(19) United States
(12) Patent Application Publication
(10) Pub. No.: US 2025/0324395 A1
(43) Pub. Date: Oct. 16, 2025

(54) GEOLOCATION DETERMINATION AND REPORTING FOR NETWORK-CONNECTED DEVICES

(71) Applicant: CenturyLink Intellectual Property LLC, Denver, CO (US)

(72) Inventor: Thomas Schwengler, Lakewood, CO (US)

(73) Assignee: CenturyLink Intellectual Property LLC, Denver, CO (US)

(21) Appl. No.: 19/070,068

(22) Filed: Mar. 4, 2025

Related U.S. Application Data
(60) Provisional application No. 63/632,844, filed on Apr. 11, 2024.

(51) Int. Cl. H04W 64/00; H04W 84/06

(52) U.S. Cl. CPC H04W 64/006; H04W 84/06

(57) ABSTRACT

Novel tools and techniques are provided for implementing geolocation determination and reporting for network-connected devices. In various examples, a computing system may receive wireless device location data sent from wireless transceivers over a wireless connection to a target device, and may receive wired device location data sent from network devices over a wired connection to a modem communicatively coupled to the target device. The computing system may query location databases for, or otherwise determine, first geographical location information for each wireless transceiver and/or for second geographical location information for each network device. The computing system may calculate an estimated geographical location for the target device based on a combination of: the wireless device location data and/or the first geographical location information; and the wired device location data and/or the second geographical location information. The computing system may perform a task using the estimated geographical location information of the target device.

### CROSS-REFERENCE TO RELATED APPLICATIONS

This application claims the benefit of U.S. Provisional Application No. 63/632,844 filed Apr. 11, 2024, entitled “Geolocation Determination and Reporting for Network Connected Device,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing geolocation functionalities, and, more particularly, to methods, systems, and apparatuses for implementing geolocation determination and reporting for network-connected devices.

### BACKGROUND

Location determination and accuracy is increasingly important in modern networks. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing geolocation determination and reporting for network-connected devices, in accordance with various embodiments.

FIG. 2 depicts an example data flow when implementing geolocation determination and reporting for network-connected devices, in accordance with various embodiments.

FIGS. 3A-3D depict flow diagrams illustrating an example method for implementing geolocation determination and reporting for network-connected devices, in accordance with various embodiments.

FIGS. 4A-4F depict flow diagrams illustrating another example method for implementing geolocation determination and reporting for network-connected devices, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a computing system may receive one or more wireless device location data sent from one or more wireless transceivers over a wireless connection to a target device, and may receive one or more wired device location data sent from one or more network devices over a wired connection to a modem communicatively coupled to the target device. The computing system may query one or more first location databases for first geographical location information for each of the one or more wireless transceivers, and may query one or more second location databases for second geographical location information for each of the one or more network devices. The computing system may calculate an estimated geographical location for the target device based on a combination of: at least one of the one or more wireless device location data or the first geographical location information for each wireless transceiver; and at least one of the one or more wired device location data or the second geographical location information for each network device. The computing system may perform a first task using the estimated geographical location information of the target device.

In other examples, a computing system of a target device may receive, over a wireless connection, one or more wireless device location data from one or more wireless transceivers; and may receive, over the wireless connection, a determined angle of arrival of signals from each of at least one wireless transceiver of the one or more wireless transceivers. The computing system may calculate an estimated geographical location for the target device based on a combination of the one or more wireless device location data and the determined angle of arrival of signals from each of the at least one wireless transceiver. The computing system may perform a first task using the estimated geographical location information.

Location determination and accuracy of location determination (e.g., accuracy in terms of meters) is increasingly important in modern networks. Accurate locations save lives during emergency calls. Accurate locations provide important sources of customer information that may be used in countless applications (e.g., navigation, alarm systems, theft prevention, lost items recovery, targeted marketing, etc.). Accurate locations are required by some federal communications commission (“FCC”) rules and regulations in some scenarios (e.g., citizens broadband radio service (“CBRS”) or 6 GHz unlicensed bands, etc.). The various embodiments provide more accurate or further refined calculations of estimated geographical location information for a target device based on a combination of at least one of the one or more wireless device location data or the first geographical location information for each wireless transceiver; and at least one of the one or more wired device location data or the second geographical location information for each network device. These and other aspects of the geolocation determination and reporting for network-connected devices are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in Xn10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “clement” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system, one or more wireless device location data sent from one or more wireless transceivers over a wireless connection to a target device; and receiving, by the computing system, one or more wired device location data sent from one or more network devices over a wired connection to a modem communicatively coupled to the target device. The method may further include querying, by the computing system, one or more first location databases for first geographical location information for each of the one or more wireless transceivers; and querying, by the computing system, one or more second location databases for second geographical location information for each of the one or more network devices. The method may further include calculating, by the computing system, an estimated geographical location for the target device based on a combination of: at least one of the one or more wireless device location data or the first geographical location information for each wireless transceiver; and at least one of the one or more wired device location data or the second geographical location information for each network device. The method may further include performing, by the computing system, a first task using the estimated geographical location information of the target device.

In another aspect, the technology relates to a system, including: a computing system, including a processing system and memory coupled to the processing system. The memory includes computer executable instructions that, when executed by the processing system, causes the system to perform operations. The operations may include receiving, from a target device, one or more wireless device location data sent from one or more wireless transceivers over a wireless connection to the target device; and receiving, from the target device, one or more wired device location data sent from one or more network devices over a wired connection to a modem communicatively coupled to the target device. The operations may further include querying one or more first location databases for first geographical location information for each of the one or more wireless transceivers; and querying one or more second location databases for second geographical location information for each of the one or more network devices. The operations may further include calculating an estimated geographical location for the target device, based on a combination of the one or more wireless device location data and the first geographical location information for each wireless transceiver and based on a combination of the one or more wired device location data and the second geographical location information for each network device. The operations may further include performing a first task using the estimated geographical location information of the target device.

In yet another aspect, the technology relates to a method, including receiving, by a computing system, one or more wireless device location data sent from one or more wireless transceivers over a wireless connection to a target device; and receiving, by the computing system, one or more wired device location data sent from one or more network devices over a wired connection to a modem communicatively coupled to the target device. The method may further include calculating, by the computing system, an estimated geographical location for the target device based on at least in part on a combination of the one or more wireless device location data and the one or more wired device location data; and performing, by the computing system, a first task using the estimated geographical location information of the target device.

In an aspect, the technology relates to a method, including: receiving, by a computing system of a target device and over a wireless connection, one or more wireless device location data from one or more wireless transceivers; and receiving, by the computing system and over the wireless connection, a determined angle of arrival of signals from each of at least one wireless transceiver of the one or more wireless transceivers. The method may further include calculating, by the computing system, an estimated geographical location for the target device based on a combination of the one or more wireless device location data and the determined angle of arrival of signals from each of the at least one wireless transceiver; and performing, by the computing system, a first task using the estimated geographical location information.

In another aspect, the technology relates to a target device, including one or more first antennas, a first orientation sensor, a processing system, and memory coupled to the processing system. The memory includes computer executable instructions that, when executed by the processing system, causes the target device to perform operations. The operations may include receiving, from one or more wireless transceivers and over a wireless connection, one or more wireless device location data; determining an orientation of the target device based on measurements of the first orientation sensor; and determining a first angle of arrival of signals received by the one or more first antennas, based at least in part on the determined orientation of the target device. The operations may further include calculating an estimated geographical location for the target device based on a combination of the one or more wireless device location data and the determined first angle of arrival of the signals received by the one or more first antennas; and performing, by the computing system, a first task using the estimated geographical location information.

In yet another aspect, the technology relates to a method, including receiving, by a computing system of a target device and over a wireless connection, one or more wireless device location data from one or more wireless transceivers; and receiving, by the computing system and over the wireless connection, a determined angle of arrival of signals from each of at least one wireless transceiver of the one or more wireless transceivers. The method may further include determining, by the computing system, an orientation of the target device based on measurements of an orientation sensor of the target device; and determining, by the computing system, a first angle of arrival of signals received by one or more first antennas of the target device based at least in part on the determined orientation of the target device. The method may further include determining, by the computing system, a second angle of arrival of the signals received by the one or more first antennas of the target device based on one or more of beamforming, null-forming, or multiple input multiple output (“MIMO”) signal techniques. The method may further include calculating, by the computing system, an estimated geographical location for the target device based on a combination of the one or more wireless device location data and at least one of the determined angle of arrival of signals from each of the at least one wireless transceiver, the determined first angle of arrival of the signals received by the one or more first antennas, or the determined second angle of arrival of the signals received by the one or more first antennas. The method may further include performing, by the computing system, a first task using the estimated geographical location information.

Various modifications and additions can be made to the embodiments discussed without departing from the scope of the invention. For example, while the embodiments described above refer to particular features, the scope of this invention also includes embodiments having different combinations of features and embodiments that do not include all of the above-described features.

### Specific Exemplary Embodiments

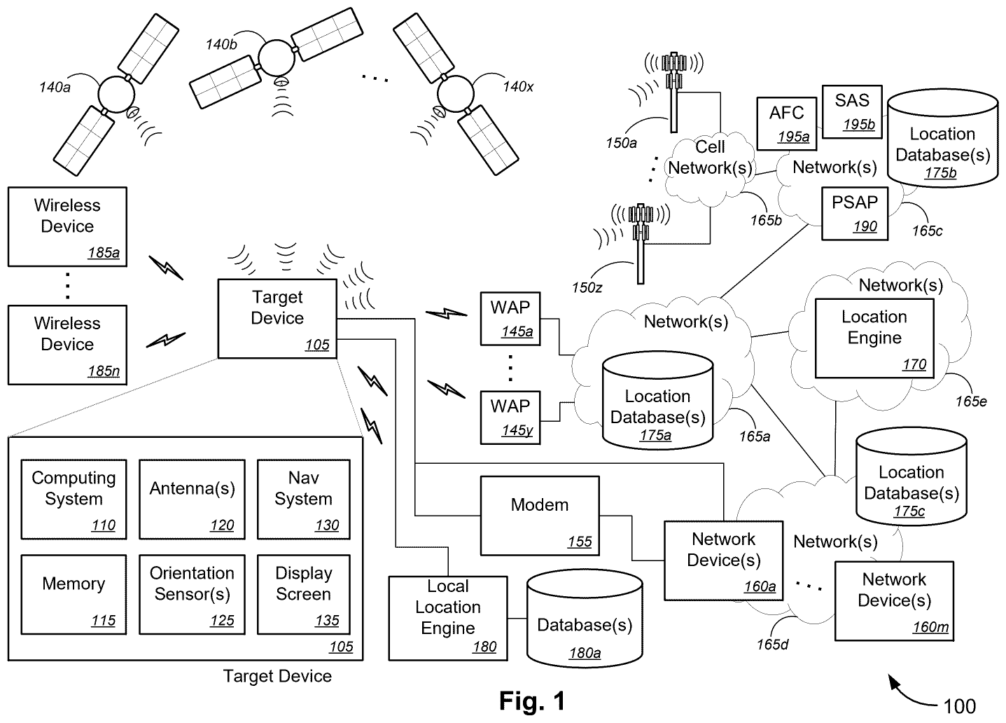

We now turn to the embodiments as illustrated by the drawings. FIGS. 1-5 illustrate some of the features of the method, system, and apparatus for implementing geolocation functionalities, and, more particularly, to methods, systems, and apparatuses for implementing geolocation determination and reporting for network-connected devices, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing geolocation determination and reporting for network-connected devices, in accordance with various embodiments. In the non-limiting example of FIG. 1, system 100 may include target device 105. In examples, the target device 105 may include computing system 110 and memory 115. In some cases, the target device 105 may further include at least one of one or more antennas 120, an orientation sensor(s) 125, a navigation system 130, and/or a display screen 135, and/or the like. In some examples, system 100 may further include a plurality of geolocation satellites 140a-140x (collectively, “geolocation satellites 140” or “satellites 140” or the like) within satellite signal range of the target device 105. In some examples, the target device 105 may comprise a wireless access point and/or wireless router (“WAP”). Alternatively or additionally, in examples, system 100 may further include a plurality of (additional) WAP devices 145a-145y (collectively, “WAP devices 145” or “WAPs 145” or the like) within WAP signal range of the target device 105. Alternatively or additionally, in some instances, system 100 may further include a cellular transceiver mounted on one of a plurality of cellular towers 150a-150z (collectively, “cellular towers 150” or “towers 150” or the like). Alternatively or additionally, in some cases, system 100 may further include a modulator-demodulator (“modem”) 155 and one or more network devices 160a-160m (collectively, “network devices 160,” “network equipment 160,” “devices 160,” or “equipment 160” or the like) that are communicatively coupled with modem 155. In some instances, the one or more network devices 160 may include at least one of a network switch, a network router, or a firewall, and/or the like. System 100 may further include one or more network(s) 165a-165e (collectively, “network(s) 165” or the like).

In some embodiments, system 100 may further include location engine 170, which may be a remote or network-based location engine, and one or more location databases 175a-175c (collectively, “location database(s) 175” or the like). In some examples, system 100 may further include a local location engine 180 and corresponding database(s) 180a that are local to the target device 105 (e.g., located at the same location, facility, customer premises, or other geographical location, or the like). In examples, WAP devices 145 may communicatively couple with network(s) 165a. In some instances, location database(s) 175a may be located within network(s) 165a. In some examples, cellular towers 150 may communicatively couple with cellular network(s) 165b (e.g., 2G, 3G, 4G, and/or 5G network(s), etc.), which may communicatively couple with network(s) 165c. In some cases, location database(s) 175b may be located within network(s) 165c. In examples, location database(s) 175c and network devices 160a-160m may be located within network(s) 165d. In some instances, location engine 170 may be located within network(s) 165c. In some examples, network(s) 165a-165e may communicatively couple with each other, either directly or indirectly.

According to some embodiments, system 100 may further include one or more wireless devices 185a-185n (collectively, “wireless devices 185” or the like). Herein, m, n, x, y, and z are non-negative integer numbers that may be either all the same as each other, all different from each other, or some combination of same and different (e.g., one set of two or more having the same values with the others having different values, a plurality of sets of two or more having the same value with the others having different values, etc.). In some instances, system 100 may further include a public safety access point (“PSAP”) 190. In examples, system 100 may further include an automatic frequency coordination (“AFC”) system 195a or a spectrum allocation system (“SAS”) 195b. AFC system 195a is a system to which service providers or operators must report locations of devices that emit wireless signals (such as a WAP, etc.) operating at standard power in the 6 GHz band (e.g., Wi-Fi 6E or 7 devices, or the like), while SAS 195b is a system to which service providers or operators must repost locations of such devices operating in the 3.55-3.7 GHZ band (e.g., citizens broadband radio service devices (“CBSDs”) operating in the citizens broadband radio service (“CBRS”) band, or the like). In some instances, PSAP 190, AFC system 195a, and/or SAS 195b may be located within network(s) 165c. The locations of the various components of system 100 in FIG. 1 are merely for illustration and are not limited to such, and the various components may each be located in any of these or other networks and in the same network or different networks with one or more of the other components without deviating from the scope of the various embodiments.

According to some embodiments, unless otherwise indicated, network(s) 165a-165e may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 165a-165e may include an access network of the service provider (e.g., an Internet service provider (“ISP”)). In another embodiment, the network(s) 165a-165e may include a core network of the service provider and/or the Internet.

In some instances, the target device(s) 105 and the wireless devices 185a-185n may each include, but is not limited to, one of a desktop computer, a laptop computer, a tablet computer, a smart phone, a mobile phone, a navigation system device (e.g., a global navigation satellite system (“GNSS”) receiver or device such as a Global Positioning System (“GPS”)-based device, a Global'naya Navigatsionnaya Sputnikovaya Sistema or Global Navigation Satellite System (“GLONASS”)-based device, a BeiDou Navigation Satellite System-based device, or a Galileo Positioning System-based device, etc.), a wireless access point device, a modem, a network device, or any suitable device capable of communicating with at least one of geolocation satellites 140a-140x, WAPs 145a-145y, cellular transceivers mounted on cellular towers 150a-150z, wireless devices 185a-185n, modem 155, and/or local location engine 180, and/or the like, over corresponding wireless connections (denoted in FIG. 1 by lightning bolt symbols or waveform symbols) or wired connections (denoted in FIG. 1 by solid lines between components).

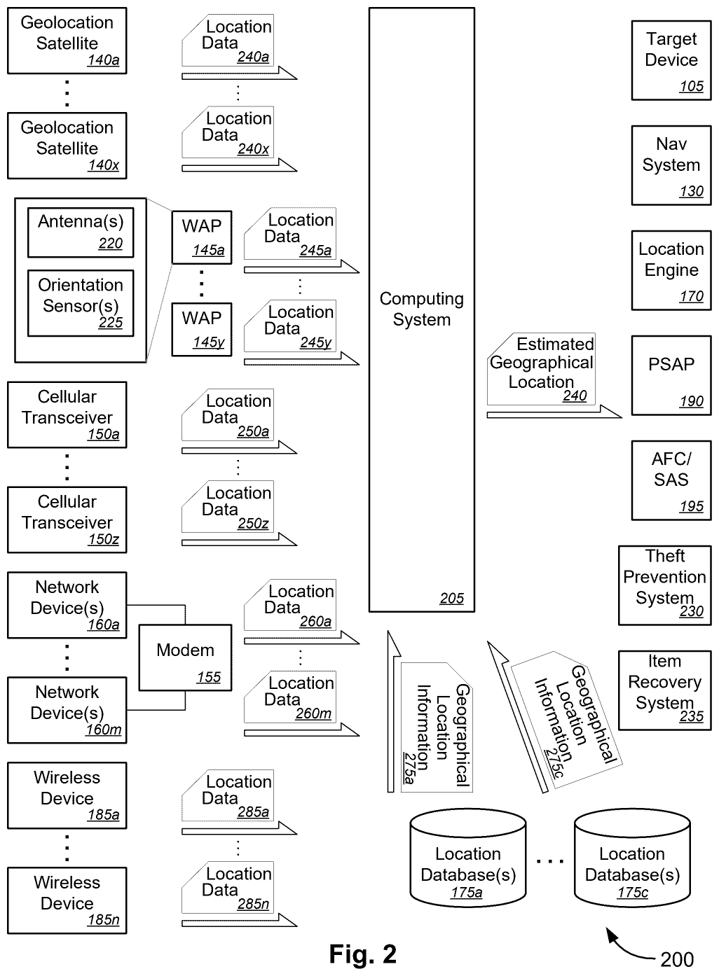

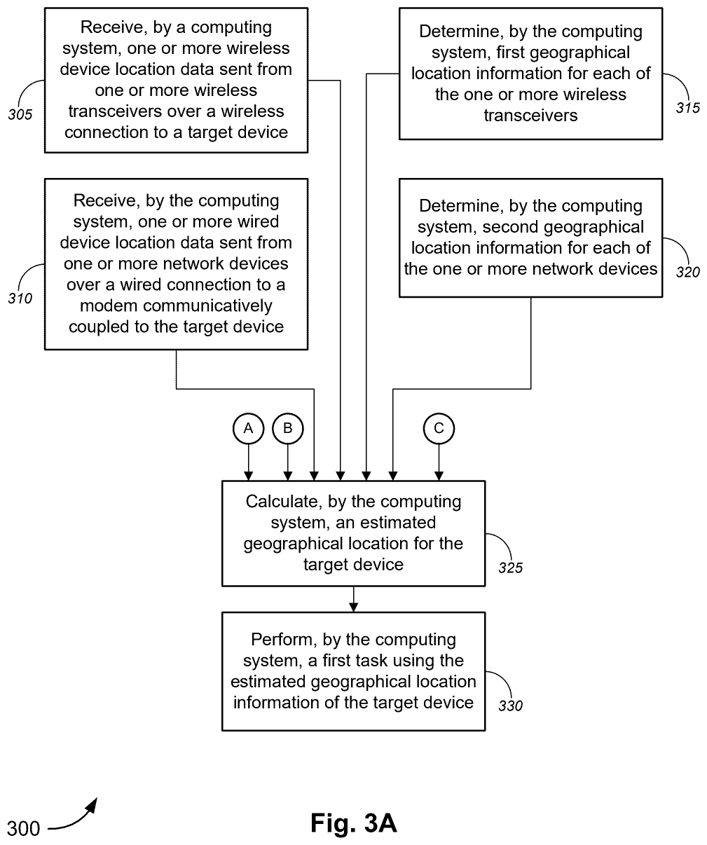

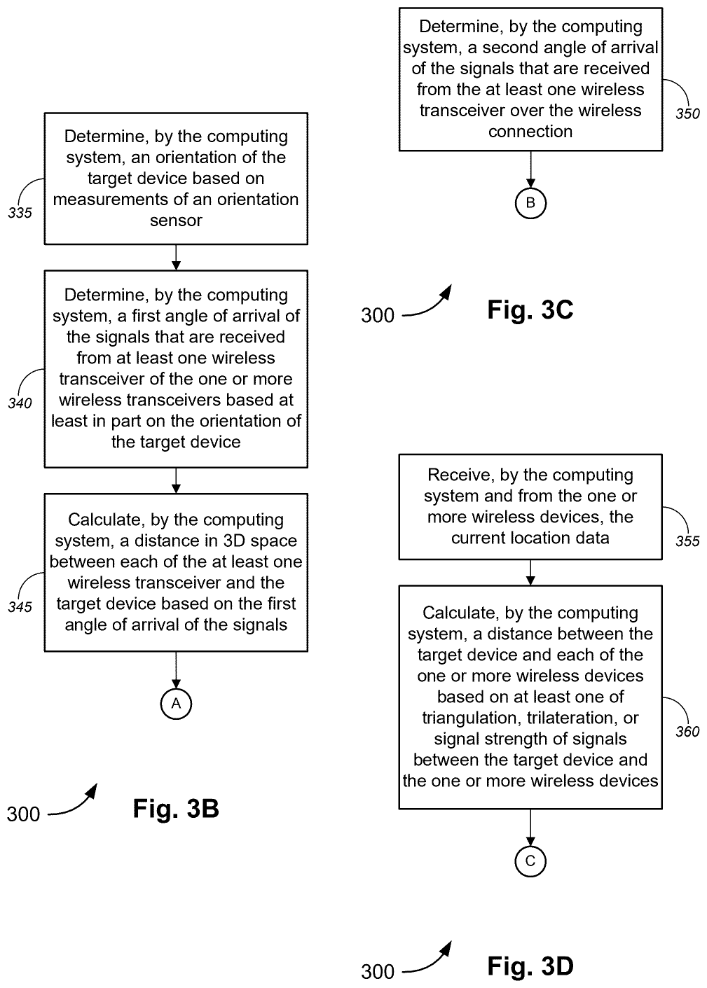

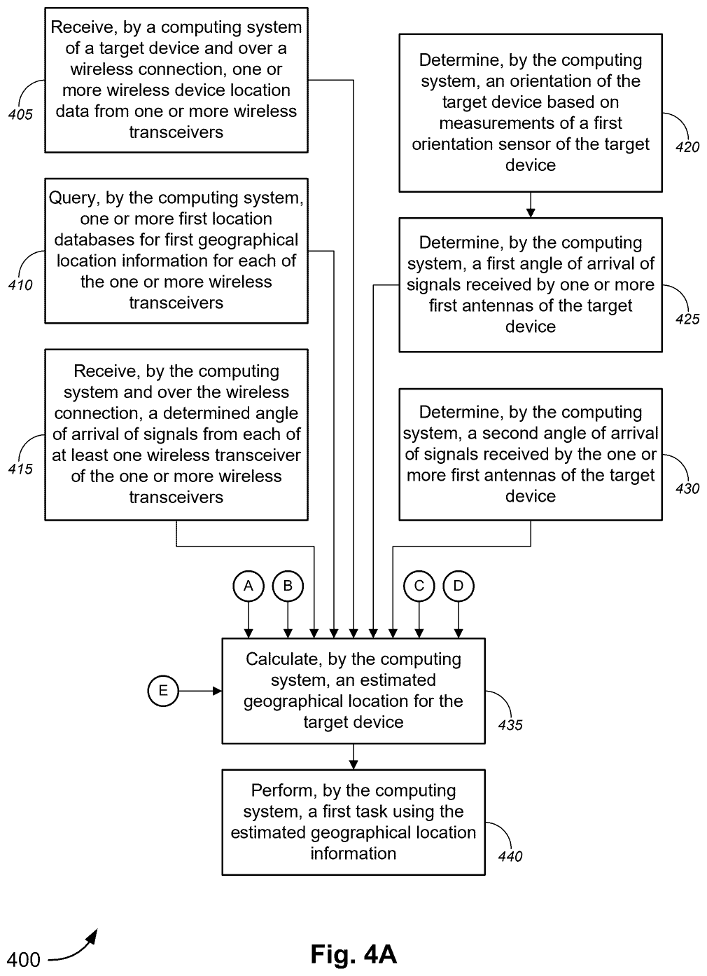

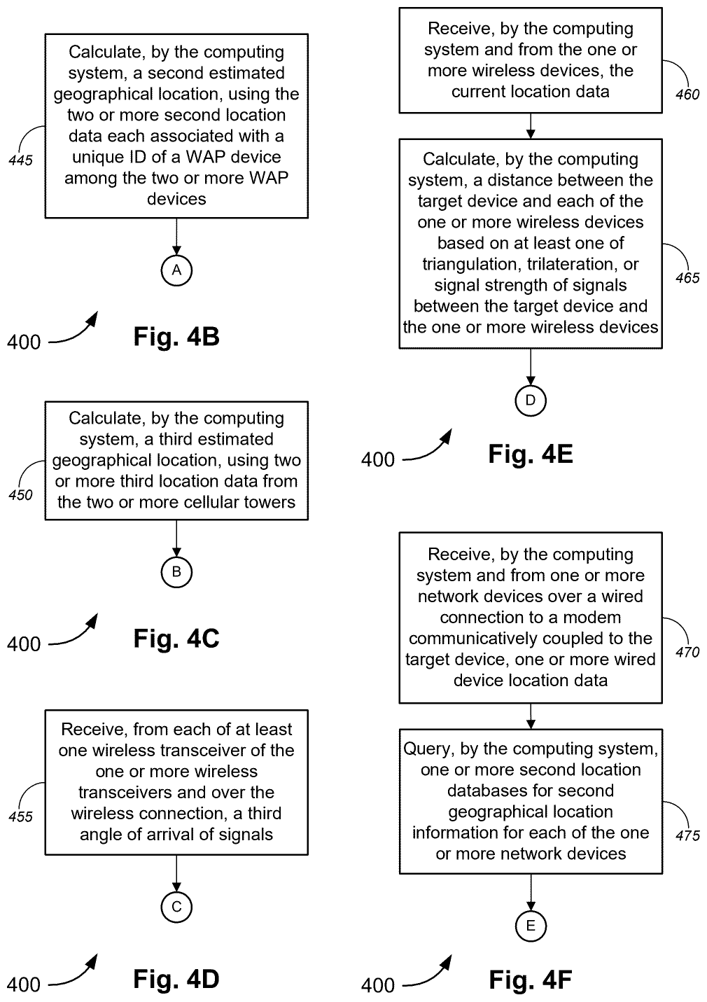

In operation, target device 105, location engine 170, and/or local location engine 180 (collectively, “computing system”) may perform methods for implementing geolocation determination and reporting for network-connected devices, as described in detail with respect to FIGS. 2-4. For instance, example data flow 200 as described below with respect to FIG. 2, example methods 300 and 400 as described below with respect to FIGS. 3A-3D and 4A-4F, respectively, may be applied with respect to the operations of system 100 of FIG. 1.

FIG. 2 depicts an example data flow 200 when implementing geolocation determination and reporting for network-connected devices, in accordance with various embodiments. Referring to the non-limiting example of FIG. 2, computing system 205 (which may correspond to target device 105, location engine 170, or local location engine 180 of FIG. 1, or the like) may receive location data 240a-240x from corresponding geolocation satellites 140a-140x that are within satellite signal range of target device 105. The computing system 205 may calculate an estimated geographical location 240 based at least in part on two or more of location data 240a-240x, in some cases, based at least in part on one or more of satellite-based positioning techniques, a number of geolocation satellites among the two or more geolocation satellites, signal strength of satellite signals from the two or more geolocation satellites, or satellite key parameters included in each of the satellite signals. In wide-open spaces, satellite signals from two or more (ideally four or more) satellites provide direct, unobstructed signal connection to the target device, and thus estimated geographical locations may be relatively accurate. In urban areas or areas where tall structures (whether natural, such as mountains, cliff-sides, etc., or man-made, such as buildings, bridges, etc.,), satellite signals may reflect off such structures, in some cases, resulting in multipath signals. Multipath or reflected signals, being indirect signals, increase the signal path length to the target device, resulting in false or inaccurate results when calculating estimated geographical location of the target device. Within buildings, the building's materials for its walls, floors, and/or roof may interfere with the satellite signals, which in some cases may enter the building through reflections from nearby structures in through windows and off interior walls, which similarly results in false or inaccurate estimated geographical location results for target devices within the buildings.

Alternatively or additionally, computing system 205 may receive location data 245a-245y from corresponding WAP devices 145a-145y that are within WAP signal range of the target device 105. In some cases, each location data 245 may include or may be associated with an identifier (“ID”) (in some cases, unique ID) of a WAP device among the WAP devices 145a-145y. In examples, the ID may include at least one of a base station ID (“BSSID”), a media access control (“MAC”) address, or a service set ID (“SSID”), and/or the like. In some examples, computing system 205 may calculate the estimated geographical location 240 based at least in part on two or more of location data 245a-245y, in some cases, based at least in part on one or more of wireless device-based positioning techniques, trilateration techniques, a number of WAP devices, signal strength of wireless signals from the two or more WAP devices, signaling time of the wireless signals, WAP fingerprinting, or angle of arrival measurements from the two or more WAP devices, and/or the like. Using WAP fingerprinting based on the unique ID of two or more WAP devices, locations of these WAP devices, if known and stored in a database (e.g., such as location databases 175a-175c), may be retrieved. Based on the retrieved location (if applicable) and based on signal strength and/or signaling time of wireless signals from the two or more WAP devices, triangulation techniques and/or trilateration techniques may be used to calculate the estimated geographical location 240 of the target device 105 at least in a two-dimensional (“2D”) coordinate basis with the overlapping signal ranges/radii of the two or more WAP devices.

According to some embodiments, the one or more antennas 120 of target device 105 (as shown in FIG. 1) each includes a microstrip patch antenna, a microstrip slot antenna, a microstrip travelling antenna, or a printed dipole antenna, and/or the like. In some examples, the one or more orientation sensors 125 of target device 105 (as shown in FIG. 1) each includes at least one of an accelerometer, a tilt sensor, a gyroscope, or a gravimeter, and/or the like. Using the one or more antennas 120, the computing system 205 can determine an angle at which the target device 105 is receiving wireless signals from other devices (such as WAP devices 145a-145y, wireless devices 185a-185n, etc.) and uses that information to determine the estimated geographical location 240 of the target device 105, at least relative to these other devices. In some cases, the computing system 205 determines an orientation of the target device 105 (e.g., vertical orientation based on wall-mounting, horizontal orientation based on level-surface mounting, angled orientation based on angled-mounting, etc.) based on measurements of the one or more orientation sensors 125, and determines a first angle of arrival of signals received by the target device 105 based at least in part on the orientation of the target device 105. In such cases, the estimated geographical location 240 may be calculated based at least in part on the first angle of arrival of signals and/or based on a distance in three-dimensional (“3D”) space between each of the at least one WAP device 145 and the target device 105 that is calculated based on the first angle of arrival of signals. Alternatively or additionally, the target device 105 determines a second angle of arrival of the signals received by the target device 105, in some cases, based on one or more of beamforming, null-forming, or multiple input multiple output (“MIMO”) signal techniques. In such cases, the estimated geographical location 240 may be calculated based at least in part on the second angle of arrival of the signals. With angle of arrival measurements and/or orientation sensing, 3D mapping may be performed using elevation and azimuth determinations, measurements, or calculations to further refine the estimated geographical location results.

Alternatively or additionally, in some embodiments, at least one of the WAP devices 145 similarly includes one or more antennas 220 and/or one or more orientation sensors 225. In some cases, the one or more antennas 220 each includes a microstrip patch antenna, a microstrip slot antenna, a microstrip travelling antenna, or a printed dipole antenna, and/or the like. In some examples, the one or more orientation sensors 225 each includes at least one of an accelerometer, a tilt sensor, a gyroscope, or a gravimeter, and/or the like. In some cases, the at least one WAP device 145 determines an orientation of the at least one WAP device 145 (e.g., vertical orientation based on wall-mounting, horizontal orientation based on level-surface mounting, angled orientation based on angled-mounting, etc.) based on measurements of the one or more orientation sensors 225, and determines a third angle of arrival of signals received by the at least one WAP device 145 based at least in part on the orientation of the WAP device 145. In such cases, the estimated geographical location 240 may be calculated based at least in part on the third angle of arrival of signals and/or based on a distance in 3D space between each of the at least one WAP device 145 and the target device 105 that is calculated based on the third angle of arrival of signals. Alternatively or additionally, the at least one WAP device 145 determines a fourth angle of arrival of the signals received by the at least one WAP device 145, in some cases, based on one or more of beamforming, null-forming, or MIMO signal techniques. In such cases, the estimated geographical location 240 of the target device 105 may be calculated based at least in part on the fourth angle of arrival of the signals. With angle of arrival measurements and/or orientation sensing, 3D mapping may be performed using elevation and azimuth determinations, measurements, or calculations to further refine the estimated geographical location results. In some examples, the estimated geographical location 240 of the target device 105 may be calculated based at least in part on a combination of the first through fourth angles of arrival of the signals.

Alternatively or additionally, computing system 205 may receive location data 250a-250z from corresponding cellular transceivers/towers 150a-150z. In some instances, location data 250a-250z may each include or may be associated with a cellular ID and signal offset data (e.g., pseudo-noise (“PN”) offset, etc.) sent from a cellular transceiver/tower among the cellular transceivers/towers 150a-150z. In some cases, the location data 250a-250z may include other standard key 3GPP parameters used in 2G, 3G, 4G, or 5G wireless networks. As used herein, “cellular ID” (also referred to as “physical cell ID (“PCI”)) may refer to a physical layer cell identifier for 4G LTE or 5G that is used to indicate the physical identity of a cell during cell selection processes, downlink synchronization, etc. “PN offset,” as used herein, may refer to a characteristic of a signal from a cell on a tower that uniquely identifies the cell, and may include a fixed pattern that resembles random noise that repeats a number of times per second and corresponds to timing of the cell's short codes relative to system time. In some instances, all cells on all towers may use the same pattern, with the signals from each cell being offset by a delay corresponding to the cell's PN offset, with the cells in an area having a different PN offset (e.g., separated by a difference in PN offsets of 3 or 6, etc.), devices may select a PN offset to select which cell with which to communicate. In some cases, computing system 205 may calculate the estimated geographical location 240 based at least in part on one or more of trilateration techniques or triangulation techniques using location information of the cellular transceivers/towers 150a-150z that are retrieved from location database(s) based on the cellular ID and/or signal offset data.

Based on the identification of the cell using the PCI and/or PN offset, locations of two or more cellular towers 150a-150z within cellular signal range of the target device 105 may be retrieved from a database (e.g., at least one of location databases 175a-175c, etc.). Using the retrieved locations of the two or more cellular towers 150a-150z, triangulation techniques and/or trilateration techniques may be used to calculate the estimated geographical location 240 of the target device 105 at least in a 2D coordinate basis with the overlapping signal ranges/radii of the two or more cellular towers 150a-150z.

Alternatively or additionally, computing system 205 may receive location data 260a-260m from corresponding network devices 160a-160m received from modem 155 (via wired or wireless connection between the modem 155 and target device 105) via wired connection (e.g., optical connection or physical wire connection) between each network device 160 and the modem 155 over a network (e.g., network(s) 165d of FIG. 1, or the like). In such cases, the estimated geographical location 240 may be calculated based at least in part on one or more of optical time domain reflectometry (“OTDR”), transmission line reflectometry, round-trip delay measurements, measurement delays to timing sources, or connection lengths from known network devices among the one or more network devices 160, and/or the like. Network devices, whose IDs (e.g., MAC addresses, associated telephone numbers, point-to-point protocol (“PPP”) credentials, point-to-point protocol over Ethernet (“PPPOE”) credentials, or other wired network element IDs, etc.) are known and whose locations are stored in and accessible from at least one of location database(s) 175a-175c, may be used as reference for calculating the estimated geographical location 240 of the target device 105. For instance, based on the known location of at least one network device and based on either round-trip delay measurements or measurements of signal transmission round-trip times, etc., distances may be estimated to the modem 155, and target device distance from the modem may be estimated based on signal strength to the modem (for wireless connection between the modem and the target device) or based on estimated cable length to the modem (for wired connection between the modem and the target device). In some cases, the wired connection may include connection via optic fiber, copper lines, digital subscriber line (“DSL”), coaxial cable, or Ethernet LAN or WAN, etc.

Alternatively or additionally, computing system 205 may receive (using device to device queries) location data 285a-285n from corresponding wireless devices 185a-185n that are within signal range of the target device 105, in some cases, based on a mobile device data transmission protocol (e.g., simple network management protocol (“SNMP”), etc.). In some instances, the computing system 205 may broadcast or target a request for location data from neighboring devices (in this case, the wireless devices 185a-185n). In some cases, location data 285 may include a current location of the corresponding wireless device 185, and optionally an estimate of the accuracy of the current location. In such cases, the estimated geographical location 240 may be calculated based at least in part on a distance between the target device and each of the one or more wireless devices 185a-185n that may be calculated, in some cases, based on at least one of triangulation, trilateration, or signal strength of signals between the target device 105 and one or more of the wireless devices 185a-185n. Based on location information for each of the one or more wireless devices 185, the location of the target device 105 may be estimated based on signal strength from the one or more wireless devices 185 and/or based on triangulation and/or trilateration of signals from the one or more wireless devices 185.

Alternatively or additionally, computing system 205 may receive geographical location information 275a-275c from location databases 175a-175c. In examples, the geographical location information 275a-275c includes at least one of location data 240 among location data 240a-240x, location data 245 among location data 245a-245y, location data 250 among location data 250a-250z, location data 260 among location data 260a-260m, location data 285 among location data 285a-285n, a cached or stored location of the target device 105, a cached or stored location of at least one WAP device 145 among the WAP devices 145a-145y, a cached or stored location of at least one cellular tower 150 among the cellular towers 150a-150z, a cached or stored location of at least one network device 160 among the network devices 160a-160m, or a cached or stored location of at least one wireless device 185 among the wireless devices 185a-185n, and/or the like.

In examples, the estimated geographical location 240 may be calculated or estimated based on a combination of two or more of at least one location data 240 among location data 240a-240x, at least one location data 245 among location data 245a-245y, at least one location data 250 among location data 250a-250z, at least one location data 260 among location data 260a-260m, at least one location data 285 among location data 285a-285n, and/or at least one geographical location information 275 among geographical location information 275a-275c, and/or the like. By combining location data from two or more different types of sources (e.g., two or more geolocation satellites 140a-140x, two or more WAP devices 145a-145y, two or more cellular transceivers/towers 150a-150z, two or more network devices 160a-160m, two or more wireless devices 185a-185n, etc.), calculation of the estimated geographical location 240 may be refined to produce more accurate results (e.g., when initial confidence value is not met through traditional GNSS location determination, such as described in detail below).

In some examples, the computing system 205 first estimates GNSS positioning and error based on the number of satellites, signal strengths, and standard GNSS key parameters. Second, the computing system 205 optionally or additionally enters a scanning mode to listen to any signal from neighboring wireless devices, using unique IDs (e.g., BSSID, MAC address, SSID, etc.), and using techniques in Wi-Fi positioning systems (e.g., signal strengths, trilateration, fingerprinting, angle of arrival measurements, signaling time, etc.). Third, the computing system 205 optionally or additionally enters a scanning mode to detect all cellular 2G, 3G, 4G, and/or 5G signals, and records corresponding cell ID, PN offset, PCI, and/or other standard key 3GPP parameters used in 2G, 3G, 4G, and/or 5G cellular networks. Fourth, the computing system 205 optionally or additionally enters a scanning mode to measure round trip delays to wired device identifiers (e.g., MAC addresses, telephone numbers, PPP or PPPOE credentials, or other wired network element identifiers) over wired connections (e.g., using optic fiber, copper lines, digital subscriber line (“DSL”), coaxial cable, or Ethernet LAN or WAN, etc.). Fifth, the computing system 205 optionally or additionally communicates with one or more wireless devices 185a-185n, and obtains location data 285a-285n from the one or more wireless devices 185a-185n. Based on the location data 285a-285n of the one or more wireless devices 185a-185n and based on a determination of distance and/or relative positioning between the target device 105 and the one or more wireless devices 185-185n, the computing system 205 may calculate the estimated geographical location 240 for the target device 105. In one or more of the first through fifth processes above, the computing system 205 may optionally or additionally report the applicable results from the first through fifth steps to a location engine (e.g., location engine 170 or local location engine 180, etc.), which uses a database of known locations and estimates the location and its accuracy from known devices. In examples, the computing system 205 optionally or additionally reports the estimated geographical location 240 to the location engine for subsequent use. Sixth, the computing system 205 optionally or additionally calculates estimated geographical location 240 based on a combination of the results from the first through fifth steps.

In some embodiments, the first through sixth processes may be implemented in sequence, and if a confidence score for a corresponding estimate at each of these processes passes a selected threshold value (e.g., confidence score within a selected threshold distance (e.g., within 20 m, within 10 m, within 5 m, or within 1 m, etc.) or confidence score above a threshold percentage confidence value (e.g., greater than 80%, greater than 90%, greater than 95%, etc.)), the calculation of the estimated geographical location 240 stops at that process without moving to the next. For example, if the error calculation for the estimates of the GNSS positioning, which are based on location data 240a-240x, passes a selected threshold value (e.g., confidence or error score within the selected threshold distance or confidence or error score above the threshold percentage confidence value, etc.), the estimated GNSS positioning is used as the estimated geographical location 240. If not, techniques in Wi-Fi-based positioning are used (as described above with respect to the second process). If the confidence score for the estimated geographical location, which is based on the location data 245a-245y, passes a selected threshold value (e.g., confidence score within the selected threshold distance or confidence score above the threshold percentage confidence value, etc.), the calculation of the estimated geographical location 240 stops at the second process without moving to the next. If not, techniques in cellular-tower-based positioning are used (as described above with respect to the third process). If the confidence score for the estimated geographical location, which is based on the location data 250a-250z, passes a selected threshold value (e.g., confidence score within the selected threshold distance or confidence score above the threshold percentage confidence value, etc.), the calculation of the estimated geographical location 240 stops at the third process without moving to the next. If not, techniques in network device-based positioning are used (as described above with respect to the fourth process). If the confidence score for the estimated geographical location, which is based on the location data 260a-260m, passes a selected threshold value (e.g., confidence score within the selected threshold distance or confidence score above the threshold percentage confidence value, etc.), the calculation of the estimated geographical location 240 stops at the fourth process without moving to the next. If not, techniques in positioning based on wireless devices 185 are used (as described above with respect to the fifth process). If the confidence score for the estimated geographical location, which is based on the location data 285a-285n, passes a selected threshold value (e.g., confidence score within the selected threshold distance or confidence above the threshold percentage confidence value, etc.), the calculation of the estimated geographical location 240 stops at the fifth process without moving to the next. If not, the estimated geographical location 240 may be calculated based on a combination of location data 240 among location data 240a-240x, location data 245 among location data 245a-245y, location data 250 among location data 250a-250z, location data 260 among location data 260a-260m, location data 285 among location data 285a-285n, a cached or stored location of the target device 105, a cached or stored location of at least one WAP device 145 among the WAP devices 145a-145y, a cached or stored location of at least one cellular tower 150 among the cellular towers 150a-150z, a cached or stored location of at least one network device 160 among the network devices 160a-160m, or a cached or stored location of at least one wireless device 185 among the wireless devices 185a-185n, and/or the like. Alternatively, the estimated geographical location 240 may be calculated based on the confidence scores of the estimated geographical location results of the first through fifth processes above (i.e., the estimated geographical location result having the highest confidence score).

In examples, application programming interfaces (“APIs”) allow for location-based services, and can be provided at chipset, firmware, and applications developer level. In some examples, APIs may allow devices to send multiple signal levels and unique identifiers to the location engine, which sends back an estimate of the device's position. APIs may be used to query a specific identifier location (whether wired or wireless device). APIs may also be used to report estimated locations, using previous information, including when intermittent GNSS signals are acquired. In some cases, APIs may additionally be used to send estimated locations as well as accuracy data associated with the estimated locations. In some examples, APIS may also be used to send information regarding the source of location, in some cases, including a combination of one or more signals from GNSS, Wi-Fi, 2G, 3G, 4G, 5G, and/or wired devices.

In the case that the computing system 205 is part of the target device 105, the estimated geographical location 240 is calculated on the target device 105. In the case that the computing system 205 is external to the target device 105, the location data (e.g., two or more of location data 240a-240x, two or more of location data 245a-245y, two or more of location data 250a-250z, one or more of location data 260a-260m, one or more of location data 285a-285n, and/or one or more of geographical location information 275a-275c, and/or the like) is sent to the computing system 205 (e.g., within location engine 170 and/local location engine 180, etc.), which performs calculation of the estimated geographical location 240 of target device 105, and sends the estimated geographical location 240 back (e.g., to the target device 105 or other requesting device on behalf of an owner or operator of target device 105).

In some examples, the computing system 205 may perform a task using the estimated geographical location 240 of the target device 105. In an example, the task may include displaying, on a display screen of the target device, the estimated geographical location 240 of the target device. In the case that the computing system 205 is part of target device 105, the computing system 205 may cause or instruct display of the estimated geographical location 240 on the display screen of the target device 105. In the case that the computing system 205 is separate from the target device 105, the computing system may send the estimated geographical location 240 of the target device 105 to the target device 105 for display on the display screen of the target device 105.

In another example, the task may include providing the estimated geographical location 240 of the target device 105 as part of a navigation task initiated by the target device 105 using a navigation system 130 (which may be part of the target device 105 (such as shown, e.g., in FIG. 1) or separate from the target device 105). In yet another example, the task may include providing the estimated geographical location 240 of the target device 105 to a location engine 170 for either further location estimation performed by the location engine 170 (or by local location engine 180) or for storing the estimated geographical location 240 on a location database(s) 175a-175c using the location engine 170 (or on database(s) 180a using local location engine 180).

In still another example, the task may include sending the estimated geographical location 240 of the target device 105 to a PSAP 190 during an emergency call initiated using the target device 105. In another example, the task may include providing the estimated geographical location 240 of the target device 105 to an AFC system or an SAS 195 to determine what signal frequencies the target device 105 is allowed to use at the estimated geographical location 240 of the target device 105. In yet another example, the task may include providing the estimated geographical location 240 of the target device 105 in response to a theft prevention signal initiated on behalf of the owner or operator of the target device using a theft prevention system 230. In still another example, the task may include providing the estimated geographical location 240 of the target device 105 in response to a lost item recovery signal initiated on behalf of the owner or operator of the target device using an item recovery system 235.

FIGS. 3A-3D (collectively, “Fig. 3”) depict flow diagrams illustrating an example method 300 for implementing geolocation determination and reporting for network-connected devices, in accordance with various embodiments. Method 300 returns to FIG. 3A from FIG. 3B following the circular marker denoted, “A.” Method 300 returns to FIG. 3A from FIG. 3C following the circular marker denoted, “B.” Method 300 returns to FIG. 3A from FIG. 3D following the circular marker denoted, “C.”

In the non-limiting embodiment of FIG. 3A, method 300, at operation 305, may include receiving, by a computing system, one or more wireless device location data sent from one or more wireless transceivers over a wireless connection to a target device. At operation 310, method 300 may include receiving, by the computing system, one or more wired device location data sent from one or more network devices over a wired connection to a modem communicatively coupled to the target device. Method 300 may further include, at operation 315, querying, by the computing system, one or more first location databases for first geographical location information for each of the one or more wireless transceivers. Method 300 may further include querying, by the computing system, one or more second location databases for second geographical location information for each of the one or more network devices (at operation 320).

At operation 325, method 300 may include calculating, by the computing system, an estimated geographical location for the target device. Method 300 may further include, at operation 330, performing, by the computing system, a first task using the estimated geographical location information of the target device. In an example, calculating the estimated geographical location (at operation 325) may be based on the one or more wireless device location data (from operation 305). In another example, calculating the estimated geographical location (at operation 325) may be based on one or more wired device location data (from operation 310). In yet another example, calculating the estimated geographical location (at operation 325) may be based on the first geographical location information (from operation 315). In still another example, calculating the estimated geographical location (at operation 325) may be based on the second geographical location information (from operation 320). In another example, calculating the estimated geographical location (at operation 325) may be based on at least in part on a combination of the one or more wireless device location data (from operation 305) and the one or more wired device location data (from operation 310). In yet another example, calculating the estimated geographical location (at operation 325) may be based on a combination of (1) at least one of the one or more wireless device location data (from operation 305) or the first geographical location information for each wireless transceiver (from operation 315) and (2) at least one of the one or more wired device location data (from operation 310) or the second geographical location information for each network device (from operation 320). In still another example, calculating the estimated geographical location (at operation 325) may be (a) based on a combination of the one or more wireless device location data (from operation 305) and the first geographical location information for each wireless transceiver (from operation 315) and (b) based on a combination of the one or more wired device location data (from operation 310) and the second geographical location information for each network device (from operation 320).

In examples, the computing system may be one of a computing system of the target device, a local location engine, a network-based location engine, a server, a cloud computing system, or a distributed computing system, and/or the like. In some examples, the first task may include one of displaying, on a display screen of the target device, the estimated geographical location of the target device; sending the estimated geographical location of the target device to the target device for display on the display screen of the target device; sending the estimated geographical location of the target device to a PSAP during an emergency call initiated using the target device; providing the estimated geographical location of the target device as part of a navigation task initiated by the target device; providing the estimated geographical location of the target device in response to a theft prevention signal initiated on behalf of an owner or operator of the target device; providing the estimated geographical location of the target device in response to a lost item recovery signal initiated on behalf of the owner or operator of the target device; or providing the estimated geographical location of the target device to an AFC system or an SAS to determine what signal frequencies the target device is allowed to use at the estimated geographical location of the target device; and/or the like.

According to some embodiments, the one or more wireless transceivers each includes one of a geolocation satellite, a WAP device, or a cellular transceiver mounted on a cellular tower, and/or the like. In an example, the one or more wireless device location data include two or more first location data each associated with current satellite positioning data for the target device sent from a geolocation satellite among two or more geolocation satellites within satellite signal range of the target device. In some cases, calculating the estimated geographical location (at operation 325) includes calculating a first estimated geographical location, using the two or more first location data, based at least in part on one or more of satellite-based positioning techniques, a number of geolocation satellites among the two or more geolocation satellites, signal strength of satellite signals from the two or more geolocation satellites, or satellite key parameters included in each of the satellite signals.

Alternatively or additionally, in another example, the one or more wireless device location data include two or more second location data each associated with a unique ID of a WAP device among two or more WAP devices within WAP signal range of the target device. In some cases, calculating the estimated geographical location (at operation 325) includes calculating a second estimated geographical location, using the two or more second location data, based at least in part on one or more of wireless device-based positioning techniques, trilateration techniques, a number of WAP devices, signal strength of wireless signals from the two or more WAP devices, signaling time of the wireless signals, WAP fingerprinting, or angle of arrival measurements from the two or more WAP devices.

Alternatively or additionally, in yet another example, the one or more wireless device location data include two or more third location data each associated with a cellular ID and signal offset data sent from a cellular transceiver mounted on a cellular tower among two or more cellular towers within cellular signal range of the target device. In some cases, calculating the estimated geographical location (at operation 325) includes calculating a third estimated geographical location, using two or more third location data from the two or more cellular towers, based at least in part on one or more of trilateration techniques or triangulation techniques.

In examples, the one or more wired device location data include one or more fourth location data each associated with measurement data of a round-trip signal between the target device and a network device among the one or more network devices that are communicatively coupled via the wired connection over a network to a modem communicatively coupled to the target device. In some instances, the one or more network devices include at least one of a network switch, a network router, or a firewall, and/or the like. In such examples, calculating the estimated geographical location (at operation 325) may include calculating a fourth estimated geographical location, using the one or more fourth location data, based at least in part on one or more of OTDR, transmission line reflectometry, round-trip delay measurements, measurement delays to timing sources, or connection lengths from known network devices among the one or more network devices.

In some embodiments, target device includes an orientation sensor, which may include at least one of an accelerometer, a tilt sensor, a gyroscope, or a gravimeter, and/or the like. With reference to FIG. 3B, method 300 may further include, at operation 335, determining, by the computing system, an orientation of the target device based on measurements of the orientation sensor. At operation 340, method 300 may include determining, by the computing system, a first angle of arrival of signals that are received from at least one wireless transceiver of the one or more wireless transceivers based at least in part on the orientation of the target device. Method 300, at operation 345, may include calculating, by the computing system, a distance in 3D space between each of the at least one wireless transceiver and the target device based on the first angle of arrival of the signals. Method 300 may return to the process at operation 325 in FIG. 3A following the circular marker denoted, “A.” In such examples, calculating the estimated geographical location (at operation 325) may be further based on the calculated distance in 3D space.

Alternatively or additionally, the target device further includes one or more antennas. In some cases, the one or more antennas each includes a microstrip patch antenna, a microstrip slot antenna, a microstrip travelling antenna, or a printed dipole antenna, and/or the like. Method 300 may further include determining, by the computing system, a second angle of arrival of the signals that are received by the at least one wireless transceiver over the wireless connection, in some cases, based on one or more of beamforming, null-forming, or MIMO signal techniques, and/or the like (at operation 350). Method 300 may return to the process at operation 325 in FIG. 3A following the circular marker denoted, “B.” In such examples, calculating the estimated geographical location (at operation 325) may be further based on the second angle of arrival of the signals.

Alternatively or additionally, the target device may receive current location data from one or more wireless devices that are within signal range of the target device based on a mobile device data transmission protocol (e.g., SNMP, etc.). Method 300 may further include receiving, by the computing system and from the one or more wireless devices, the current location data (at operation 355); and calculating, by the computing system, a distance between the target device and each of the one or more wireless devices, in some cases, based on at least one of triangulation, trilateration, or signal strength of signals between the target device and the one or more wireless devices (at operation 360). Method 300 may return to the process at operation 325 in FIG. 3A following the circular marker denoted, “C.” In such examples, calculating the estimated geographical location (at operation 325) may be further based on the current location data received from the one or more wireless devices and the calculated distance between the target device and each of the one or more wireless devices.

FIGS. 4A-4F (collectively, “Fig. 4”) depict flow diagrams illustrating another example method 400 for implementing geolocation determination and reporting for network-connected devices, in accordance with various embodiments. Method 400 returns to FIG. 4A from FIG. 4B following the circular marker denoted, “A.” Method 400 returns to FIG. 4A from FIG. 4C following the circular marker denoted, “B.” Method 400 returns to FIG. 4A from FIG. 4D following the circular marker denoted, “C.” Method 400 returns to FIG. 4A from FIG. 4E following the circular marker denoted, “D.” Method 400 returns to FIG. 4A from FIG. 4F following the circular marker denoted, “E.”

In the non-limiting embodiment of FIG. 4A, method 400, at operation 405, may include receiving, by a computing system of a target device and over a wireless connection, one or more wireless device location data from one or more wireless transceivers. Method 400 may further include, at operation 410, querying, by the computing system, one or more first location databases for first geographical location information for each of the one or more wireless transceivers. Method 400 may further include receiving, by the computing system and over the wireless connection, a determined angle of arrival of signals from each of at least one wireless transceiver of the one or more wireless transceivers (at operation 415). At operation 420, method 400 may include determining, by the computing system, an orientation of the target device based on measurements of a first orientation sensor of the target device; and determining, by the computing system, a first angle of arrival of signals received by one or more first antennas of the target device based at least in part on the determined orientation of the target device (at operation 425). Method 400, at operation 430, may include determining, by the computing system, a second angle of arrival of the signals received by the one or more first antennas of the target device, in some cases, based on one or more of beamforming, null-forming, or MIMO signal techniques.

At operation 435, method 400 may include calculating, by the computing system, an estimated geographical location for the target device. Method 400 may further include, at operation 440, performing, by the computing system, a first task using the estimated geographical location information of the target device. In an example, calculating the estimated geographical location (at operation 435) may be based on the one or more wireless device location data (from operation 405). In another example, calculating the estimated geographical location (at operation 435) may be based on the first geographical location information for each wireless transceiver (from operation 410). In yet another example, calculating the estimated geographical location (at operation 435) may be based on the determined angle of arrival of signals from each of the at least one wireless transceiver (from operation 415). In still another example, calculating the estimated geographical location (at operation 435) may be based on the determined orientation of the target device (from operation 420) and/or the first angle of arrival of signals (from operation 425). In another example, calculating the estimated geographical location (at operation 435) may be based on the second angle of arrival of signals (from operation 430). In yet another example, calculating the estimated geographical location (at operation 435) may be based on a combination of the one or more wireless device location data (from operation 405) and the determined angle of arrival of signals from each of the at least one wireless transceiver (from operation 415). In still another example, calculating the estimated geographical location (at operation 435) may be based on a combination of the one or more wireless device location data (from operation 405) and the determined first angle of arrival of the signals received by the one or more first antennas (from operation 425). In an example, calculating the estimated geographical location (at operation 435) may be based on a combination of the one or more wireless device location data (from operation 405) and at least one of the determined angle of arrival of signals from each of the at least one wireless transceiver (from operation 415), the determined first angle of arrival of the signals received by the one or more first antennas (from operation 425), or the determined second angle of arrival of the signals received by the one or more first antennas (from operation 430).

In some examples, the one or more wireless device location data include two or more first location data each associated with current satellite positioning data for the target device sent from a geolocation satellite among two or more geolocation satellites within satellite signal range of the target device. In some cases, calculating the estimated geographical location (at operation 435) includes calculating a first estimated geographical location, using the two or more first location data, based at least in part on one or more of satellite-based positioning techniques, a number of geolocation satellites among the two or more geolocation satellites, signal strength of satellite signals from the two or more geolocation satellites, or satellite key parameters included in each of the satellite signals.

In examples, calculating the estimated geographical location (at operation 435) may be further based on calculating a distance in 3D space between each of the at least one wireless transceiver and the target device based on the determined angle of arrival of the signals (from operation 415).

Referring to FIG. 4B, in another example, the one or more wireless device location data include two or more second location data each associated with a unique ID of a WAP device among two or more WAP devices within WAP signal range of the target device. In some cases, method 400 may further include, at operation 445, calculating, by the computing system, a second estimated geographical location, using the two or more second location data each associated with the unique ID of a WAP device among the two or more WAP devices. In some examples, calculating the second estimated geographical location may be based at least in part on one or more of wireless device-based positioning techniques, trilateration techniques, a number of WAP devices, signal strength of wireless signals from the two or more WAP devices, signaling time of the wireless signals, WAP fingerprinting, or angle of arrival measurements from the two or more WAP devices, and/or the like. Method 400 may return to the process at operation 435 in FIG. 4A following the circular marker denoted, “A.” In such examples, calculating the estimated geographical location (at operation 435) may be further based on the second estimated geographical location for each WAP.

With reference to FIG. 4C, in yet another example, the one or more wireless device location data include two or more third location data each associated with a cellular ID and signal offset data sent from a cellular transceiver mounted on a cellular tower among two or more cellular towers within cellular signal range of the target device. In some instances, method 400, at operation 450, may include calculating, by the computing system, a third estimated geographical location, using two or more third location data from the two or more cellular towers, in some cases, based at least in part on one or more of trilateration techniques or triangulation techniques, and/or the like. Method 400 may return to the process at operation 435 in FIG. 4A following the circular marker denoted, “B.” In such examples, calculating the estimated geographical location (at operation 435) may be further based on the third estimated geographical location for each cellular transceiver or each cellular tower.

Turning to FIG. 4D, in still another example, at least one wireless transceiver of the one or more wireless transceivers further includes one or more antennas. In some cases, the one or more antennas each includes a microstrip patch antenna, a microstrip slot antenna, a microstrip travelling antenna, or a printed dipole antenna, and/or the like. In examples, the at least one wireless transceiver determines a third angle of arrival of the signals received by the at least one wireless transceiver based on one or more of beamforming, null-forming, or MIMO signal techniques, and/or the like. Method 400 may further include receiving, by the computing system and from the at least one wireless transceiver over the wireless connection, the third angle of arrival of the signals (at operation 455). Method 400 may return to the process at operation 435 in FIG. 4A following the circular marker denoted, “C.” In such examples, calculating the estimated geographical location (at operation 435) may be further based on the third angle of arrival of the signals.

With reference to FIG. 4E, in another example, the target device may receive current location data from one or more wireless devices that are within signal range of the target device based on a mobile device data transmission protocol (e.g., SNMP, etc.). Method 400 may further include receiving, by the computing system and from the one or more wireless devices, the current location data (at operation 460); and calculating, by the computing system, a distance between the target device and each of the one or more wireless devices, in some cases, based on at least one of triangulation, trilateration, or signal strength of signals between the target device and the one or more wireless devices (at operation 465). Method 400 may return to the process at operation 435 in FIG. 4A following the circular marker denoted, “D.” In such examples, calculating the estimated geographical location (at operation 435) may be further based on the current location data received from the one or more wireless devices and the calculated distance between the target device and each of the one or more wireless devices.

Referring to FIG. 4F, at operation 470, method 400 may include receiving, by the computing system and from one or more network devices over a wired connection to a modem communicatively coupled to the target device, one or more wired device location data. Method 400 may further include, at operation 475, querying, by the computing system, one or more second location databases for second geographical location information for each of the one or more network devices. Method 400 may return to the process at operation 435 in FIG. 4A following the circular marker denoted, “E.” In such examples, calculating the estimated geographical location (at operation 435) may be further based on the second geographical location information for each network device.

In some examples, the first task may include one of displaying, on a display screen of the target device, the estimated geographical location of the target device; sending the estimated geographical location of the target device to the target device for display on the display screen of the target device; sending the estimated geographical location of the target device to a PSAP during an emergency call initiated using the target device; providing the estimated geographical location of the target device as part of a navigation task initiated by the target device; providing the estimated geographical location of the target device in response to a theft prevention signal initiated on behalf of an owner or operator of the target device; providing the estimated geographical location of the target device in response to a lost item recovery signal initiated on behalf of the owner or operator of the target device; or providing the estimated geographical location of the target device to an AFC system or an SAS to determine what signal frequencies the target device is allowed to use at the estimated geographical location of the target device; and/or the like.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

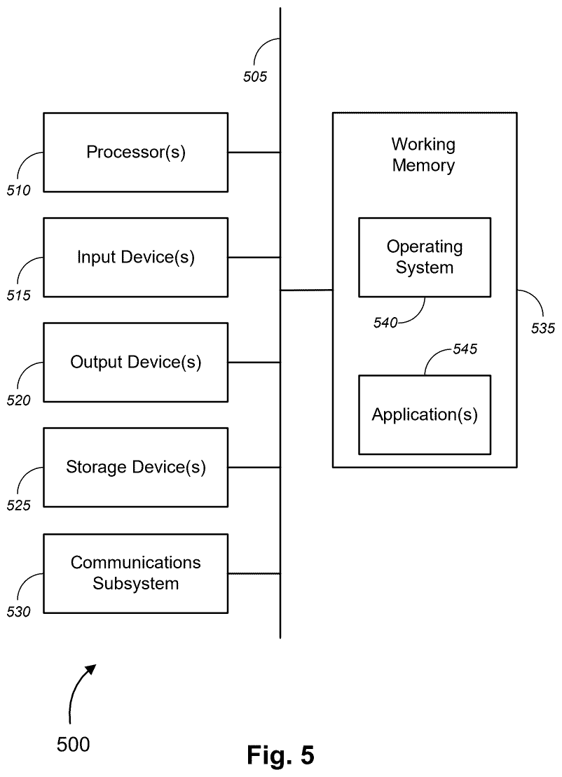

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., target device 105, computing system 110, navigation system 130, location engine 170, local location engine 180, and wireless devices 185a-185n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500-which might represent an embodiment of the computer or hardware system (i.e., target device 105, computing system 110, navigation system 130, location engine 170, local location engine 180, and wireless devices 185a-185n, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™M device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for case of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for case of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method, comprising:
receiving, by a computing system, one or more wireless device location data sent from one or more wireless transceivers over a wireless connection to a target device;
receiving, by the computing system, one or more wired device location data sent from one or more network devices over a wired connection to a modem or one of the one or more network devices communicatively coupled to the target device;
determining, by the computing system, first geographical location information for each of the one or more wireless transceivers based on at least one of the one or more wireless device location data or information associated with the one or more wireless transceivers that is stored in one or more first location storage systems;
determining, by the computing system, second geographical location information for each of the one or more network devices based on at least one of the one or more wired device location data or information associated with the one or more network devices that is stored in one or more second location storage systems;
calculating, by the computing system, an estimated geographical location for the target device based on a combination of:
at least one of the one or more wireless device location data or the first geographical location information for each wireless transceiver; and
at least one of the one or more wired device location data or the second geographical location information for each network device; and
performing, by the computing system, a first task using the estimated geographical location information of the target device.

2. The method of claim 1, wherein the computing system is one of a computing system of the target device, a local location engine, a network-based location engine, a server, a cloud computing system, or a distributed computing system.

3. The method of claim 1, wherein the first task comprises one of:
displaying, on a display screen of the target device, the estimated geographical location of the target device;
sending the estimated geographical location of the target device to the target device for display on the display screen of the target device;
sending the estimated geographical location of the target device to a public safety access point (“PSAP”) during an emergency call initiated using the target device;
providing the estimated geographical location of the target device as part of a navigation task initiated by the target device;
providing the estimated geographical location of the target device in response to a theft prevention signal initiated on behalf of an owner or operator of the target device;
providing the estimated geographical location of the target device in response to a lost item recovery signal initiated on behalf of the owner or operator of the target device; or
providing the estimated geographical location of the target device to an automatic frequency coordination system or a spectrum allocation system to determine what signal frequencies the target device is allowed to use at the estimated geographical location of the target device.

4. The method of claim 1, wherein the one or more wireless transceivers each includes one of a geolocation satellite, a wireless access point (“WAP”) device, or a cellular transceiver mounted on a cellular tower.

5. The method of claim 1, wherein the one or more wireless device location data comprise at least one of:
two or more first location data each associated with current satellite positioning data for the target device sent from a geolocation satellite among two or more geolocation satellites within satellite signal range of the target device;
two or more second location data each associated with a unique identifier (“ID”) of a WAP device among two or more WAP devices within WAP signal range of the target device; or
two or more third location data each associated with a cellular ID and signal offset data sent from a cellular transceiver mounted on a cellular tower among two or more cellular towers within cellular signal range of the target device.

6. The method of claim 5, wherein calculating the estimated geographical location comprises at least one of:
calculating a first estimated geographical location, using the two or more first location data, based at least in part on one or more of satellite-based positioning techniques, a number of geolocation satellites among the two or more geolocation satellites, signal strength of satellite signals from the two or more geolocation satellites, or satellite key parameters included in each of the satellite signals;
calculating a second estimated geographical location, using the two or more second location data, based at least in part on one or more of wireless device-based positioning techniques, trilateration techniques, a number of WAP devices, signal strength of wireless signals from the two or more WAP devices, signaling time of the wireless signals, WAP fingerprinting, or angle of arrival measurements from the two or more WAP devices; or
calculating a third estimated geographical location, using two or more third location data from the two or more cellular towers, based at least in part on one or more of trilateration techniques or triangulation techniques.

7. The method of claim 5, wherein the target device comprises an orientation sensor, the orientation sensor including at least one of an accelerometer, a tilt sensor, a gyroscope, or a gravimeter, wherein the method further comprises:
determining, by the computing system, an orientation of the target device based on measurements of the orientation sensor;
determining, by the computing system, a first angle of arrival of the signals that are received from at least one wireless transceiver of the one or more wireless transceivers based at least in part on the orientation of the target device; and
calculating, by the computing system, a distance in three-dimensional (“3D”) space between each of the at least one wireless transceiver and the target device based on the first angle of arrival of the signals;
wherein calculating the estimated geographical location is further based on the calculated distance in 3D space.

8. The method of claim 7, wherein the target device further comprises one or more antennas, wherein the one or more antennas each includes a microstrip patch antenna, a microstrip slot antenna, a microstrip travelling antenna, or a printed dipole antenna, wherein the method further comprises:
determining, by the computing system, a second angle of arrival of the signals that are received by the target device over the wireless connection, based on one or more of beamforming, null-forming, or multiple input multiple output (“MIMO”) signal techniques;
wherein calculating the estimated geographical location is further based on the second angle of arrival of the signals.

9. The method of claim 1, wherein the target device receives current location data from one or more wireless devices that are within signal range of the target device based on a mobile device data transmission protocol, wherein the method further comprises:
receiving, by the computing system and from the one or more wireless devices, the current location data;
calculating, by the computing system, a distance between the target device and each of the one or more wireless devices based on at least one of triangulation, trilateration, or signal strength of signals between the target device and the one or more wireless devices;
wherein calculating the estimated geographical location is further based on the current location data received from the one or more wireless devices and the calculated distance between the target device and each of the one or more wireless devices.

10. The method of claim 1, wherein the one or more wired device location data comprise one or more fourth location data each associated with measurement data of a round-trip signal between the target device and a network device among the one or more network devices that are communicatively coupled via the wired connection over a network to a modem communicatively coupled to the target device, wherein the one or more network devices comprise at least one of a network switch, a network router, or a firewall.

11. The method of claim 1, wherein calculating the estimated geographical location comprises:
calculating a fourth estimated geographical location, using the one or more fourth location data, based at least in part on one or more of optical time domain reflectometry (“OTDR”), transmission line reflectometry, round-trip delay measurements, measurement delays to timing sources, or connection lengths from known network devices among the one or more network devices.

12. A system, comprising:
a computing system, comprising:
a processing system; and
memory coupled to the processing system, the memory comprising computer executable instructions that, when executed by the processing system, causes the system to perform operations comprising:
receiving, from a target device, one or more wireless device location data sent from one or more wireless transceivers over a wireless connection to the target device;
receiving, from the target device, one or more wired device location data sent from one or more network devices over a wired connection to a modem communicatively coupled to the target device;
querying one or more first location databases for first geographical location information for each of the one or more wireless transceivers;
querying one or more second location databases for second geographical location information for each of the one or more network devices;
calculating an estimated geographical location for the target device, based on a combination of the one or more wireless device location data and the first geographical location information for each wireless transceiver and based on a combination of the one or more wired device location data and the second geographical location information for each network device; and
performing a first task using the estimated geographical location information of the target device.

13. The system of claim 12, wherein the computing system is one of a local location engine, a network-based location engine, a server, a cloud computing system, or a distributed computing system.

14. The system of claim 12, wherein the first task comprises one of:
displaying, on a display screen of the target device, the estimated geographical location of the target device;
sending the estimated geographical location of the target device to the target device for display on the display screen of the target device;
sending the estimated geographical location of the target device to a public safety access point (“PSAP”) during an emergency call initiated using the target device;
providing the estimated geographical location of the target device as part of a navigation task initiated by the target device;
providing the estimated geographical location of the target device in response to a theft prevention signal initiated on behalf of an owner or operator of the target device;
providing the estimated geographical location of the target device in response to a lost item recovery signal initiated on behalf of the owner or operator of the target device; or
providing the estimated geographical location of the target device to an automatic frequency coordination system or a spectrum allocation system to determine what signal frequencies the target device is allowed to use at the estimated geographical location of the target device.

15. The system of claim 12, wherein the one or more wireless device location data comprises at least one of:
two or more first location data each associated with current satellite positioning data for the target device sent from a geolocation satellite among two or more geolocation satellites within satellite signal range of the target device;
two or more second location data each associated with a unique identifier (“ID”) of a wireless access point (“WAP”) device among two or more WAP devices within WAP signal range of the target device; or
two or more third location data each associated with a cellular ID and signal offset data sent from a cellular transceiver mounted on a cellular tower among two or more cellular towers within cellular signal range of the target device.

16. The system of claim 15, wherein the one or more wired device location data comprise one or more fourth location data each associated with measurement data of a round-trip signal between the target device and a network device among the one or more network devices that are communicatively coupled via the wired connection over a network to a modem communicatively coupled to the target device, wherein the one or more network devices comprise at least one of a network switch, a network router, or a firewall, wherein calculating the estimated geographical location comprises at least one of:
calculating a first estimated geographical location, using the two or more first location data, based at least in part on one or more of satellite-based positioning techniques, a number of geolocation satellites among the two or more geolocation satellites, signal strength of satellite signals from the two or more geolocation satellites, or satellite key parameters included in each of the satellite signals;
calculating a second estimated geographical location, using the two or more second location data, based at least in part on one or more of wireless device-based positioning techniques, trilateration techniques, a number of WAP devices, signal strength of wireless signals from the two or more WAP devices, signaling time of the wireless signals, WAP fingerprinting, or angle of arrival measurements from the two or more WAP devices;
calculating a third estimated geographical location, using two or more third location data from two or more cellular towers, based at least in part on one or more of trilateration techniques or triangulation techniques; or calculating a fourth estimated geographical location, using the one or more fourth location data, based at least in part on one or more of optical time domain reflectometry (“OTDR”), transmission line reflectometry, round-trip delay measurements, measurement delays to timing sources, or connection lengths from known network devices among the one or more network devices.

17. The system of claim 12, wherein the target device receives current location data from one or more wireless devices that are within signal range of the target device based on a mobile device data transmission protocol, wherein the operations further comprise:
receiving the current location data from the one or more wireless devices;
calculating, by the computing system, a distance between the target device and each of the one or more wireless devices based on at least one of triangulation, trilateration, or signal strength of signals between the target device and the one or more wireless devices;
wherein calculating the estimated geographical location is further based on the current location data received from the one or more wireless devices and the calculated distance between the target device and each of the one or more wireless devices.

18. A method, comprising:
receiving, by a computing system, one or more wireless device location data sent from one or more wireless transceivers over a wireless connection to a target device;
receiving, by the computing system, one or more wired device location data sent from one or more network devices over a wired connection to a modem communicatively coupled to the target device;
calculating, by the computing system, an estimated geographical location for the target device based on at least in part on a combination of the one or more wireless device location data and the one or more wired device location data; and
performing, by the computing system, a first task using the estimated geographical location information of the target device.

19. The method of claim 18, wherein at least one wireless transceiver of the one or more wireless transceivers comprises one or more antennas and at least one of an accelerometer, a tilt sensor, a gyroscope, or a gravimeter, wherein the at least one wireless transceiver determines an orientation of the at least one wireless transceiver based on measurements of the at least one of the accelerometer, the tilt sensor, the gyroscope, or the gravimeter, wherein the at least one wireless transceiver determines a first angle of arrival of signals received by the at least one wireless transceiver based at least in part on the orientation of the at least one wireless transceiver, wherein the at least one wireless transceiver determines a second angle of arrival of the signals received by the at least one wireless transceiver based on one or more of beamforming, null-forming, or multiple input multiple output (“MIMO”) signal techniques, wherein the method further comprises:
receiving, by the computing system and from the at least one wireless transceiver over the wireless connection, the first angle of arrival of the signals; and
calculating, by the computing system, a distance in three-dimensional (“3D”) space between each of the at least one wireless transceiver and the target device based on the first angle of arrival of the signals; and
receiving, by the computing system and from the at least one wireless transceiver over the wireless connection, the second angle of arrival of the signals;
wherein calculating the estimated geographical location is further based on the calculated distance in 3D space and the second angle of arrival of the signals.

20. The method of claim 18, further comprising at least one of:
determining, by the computing system, first geographical location information for each of the one or more wireless transceivers based on at least one of the one or more wireless device location data or information associated with the one or more wireless transceivers that is stored in one or more first location storage systems, wherein calculating the estimated geographical location is further based on the first geographical location information or each wireless transceiver; or
determining, by the computing system, second geographical location information for each of the one or more network devices based on at least one of the one or more wired device location data or information associated with the one or more network devices that is stored in one or more second location storage systems, wherein calculating the estimated geographical location is further based on the second geographical location information for each network device.

21.-40. (canceled)
